(19) United States
(12) Patent Application Publication
(10) Pub. No.: US 2025/0166347 A1
(43) Pub. Date: May 22, 2025

(54) APPARATUS FOR CLASSIFYING OBJECT AND METHOD THEREOF

(71) Applicants: HYUNDAI MOTOR COMPANY, Seoul (KR); Kia Corporation, Seoul (KR)

(72) Inventor: Mi Rim NOH, Jeonju-si, Jeollabuk-do (KR)

(73) Assignees: HYUNDAI MOTOR COMPANY, Seoul (KR); Kia Corporation, Seoul (KR)

(21) Appl. No.: 18/752,065

(22) Filed: Jun. 24, 2024

(30) Foreign Application Priority Data
Nov. 20, 2023 (KR) 10-2023-0161395

(51) Int. Cl. G06V 10/762; G01S 7/48; G06V 10/46; G06V 10/62; G06V 10/764; G06V 10/94; G06V 20/58

(52) U.S. Cl. CPC G06V 10/762; G01S 7/4802; G06V 10/469; G06V 10/62; G06V 10/764; G06V 20/58; G06V 10/94

(57) ABSTRACT

An object classification apparatus includes a LiDAR and a processor. The processor may identify that a point corresponding to a first previous object box and a point corresponding to a second previous object box are included in an integrated object box including contour points at the predetermined time and included in an object box representing an integrated object, separate and cluster the contour points at the predetermined time into contour points representing a first object and contour points representing a second object, store the separated contour points representing the first object in association with the first object, and store the separated contour points representing the second object in association with the second object based on a number of separated contour points representing the first object and a number of separated contour points representing the second object.

### CROSS-REFERENCE TO RELATED APPLICATION

The present application claims priority to Korean Patent Application No. 10-2023-0161395, filed on Nov. 20, 2023, the entire contents of which is incorporated herein for all purposes by this reference.

### BACKGROUND OF THE PRESENT DISCLOSURE

### Field of the Present Disclosure

The present disclosure relates to an object classification apparatus and method, and more particularly, to a technique for identifying an object based on contour points obtained through a Light Detection and Ranging (LiDAR).

### Description of Related Art

Technology to detect surrounding environments and avoid obstacles is essential for autonomous vehicles.

A vehicle may obtain data indicating the position of an object around the vehicle through a LiDAR. A distance from a LiDAR to an object may be obtained through an interval between the time when laser is transmitted by the LiDAR and the time when the laser reflected by the object is received. Then, a vehicle is able to identify the location of a point included in the object in a space where the vehicle is located, based on the angle of the transmitted laser and the distance to the object.

Data obtained through the LiDAR is characterized by high resolution and a large number of points included in the data. The importance of technology for identifying objects around vehicles from data is increasing.

The information disclosed in this Background of the Invention section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an object classification apparatus and method for separating and identifying a single merged object into a plurality of objects when the plurality of objects is recognized as the merged object.

Various aspects of the present disclosure are directed to providing an object classification apparatus and method for improving tracking performance for a plurality of objects.

Various aspects of the present disclosure are directed to providing an object classification apparatus and method for identifying a position of an object through a LiDAR point.

Various aspects of the present disclosure are directed to providing an object classification apparatus and method for allocating a memory space for storing information related to objects.

Various aspects of the present disclosure are directed to providing an object classification apparatus and method for improving the accuracy of object separation.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an object classification apparatus includes a LiDAR and a processor.

According to an exemplary embodiment of the present disclosure, the processor may identify that a point corresponding to a first previous object box included in an object box representing a plurality of external objects at a previous time before a predetermined time and a point corresponding to a second previous object box included in the object box representing the plurality of external objects at the previous time are included in an integrated object box including contour points at the predetermined time and included in an object box representing an integrated object when part or all of the contour points at the predetermined time, at which the plurality of external objects are identified as the integrated object which is one object, through the LiDAR, satisfy a distribution condition, a dispersion condition, or a distribution shape condition, separate and cluster the contour points at the predetermined time into contour points representing a first object corresponding to the first previous object box and contour points representing a second object corresponding to the second previous object box, store the separated contour points representing the first object in association with the first object based on a number of separated contour points representing the first object and a number of separated contour points representing the second object, and store the separated contour points representing the second object in association with the second object.

According to an exemplary embodiment of the present disclosure, the processor may swap information related to the integrated object with information related to one of the first object and the second object and store the information related to one of the first object and the second object in a memory space where the information related to the integrated object is stored when a number of objects stored in a memory space is greater than a predetermined number, swap information related to an object with a lowest priority according to predetermined criteria among objects stored in the memory space with the information related to one of the first object and the second object and store the information related to one of the first object and the second object in a memory space where the information related to an object with the lowest priority is stored when the number of objects stored in the memory space is greater than the predetermined number, swap the information related to the integrated object with information related to the one object and store the information related to the one object in the memory space where the information related to the integrated object is stored when the number of objects stored in the memory space is less than or equal to the predetermined number, and allocate a memory space in which information related to an object is not stored among memory spaces to information related to the different object, and then store the information related to the different object in the allocated memory space when the number of objects stored in the memory space is less than or equal to the predetermined number.

According to an exemplary embodiment of the present disclosure, the processor may identify that the dispersion condition is satisfied, based on part or all of the contour points at the predetermined time being identified in both two areas separated by a straight line connecting both end points of the contour points at the predetermined time.

According to an exemplary embodiment of the present disclosure, the processor may identify whether part or all of the contour points at the predetermined time satisfy the dispersion condition or satisfy the distribution shape condition based on a peak point which is a contour point furthest from a straight line connecting both end points of the contour points at the predetermined time, which are identified as representing the integrated object.

According to an exemplary embodiment of the present disclosure, the processor may identify a first dispersion for a distance between a first straight line connecting one of the two end points and the peak point, and at least one contour point located between the one end point and the peak point, identify a second dispersion for a distance between a second straight line connecting another of the two end points and the peak point, and at least one contour point located between another end point and the peak point, and identify that the dispersion condition is satisfied based on identifying that a dispersion value of a reference straight line having a smaller dispersion value among the first dispersion and the second dispersion is included in a reference dispersion threshold range and that a dispersion value of a non-reference straight line having a larger dispersion value among the first dispersion and the second dispersion is included in a non-reference dispersion threshold range which is different from the reference dispersion threshold range. At least one contour point located between the one end point and the peak point may be located in an area between a straight line passing through the one end point and perpendicular to the first straight line and a straight line passing through the peak point and perpendicular to the first straight line. At least one contour point located between another end point and the peak point may be located in an area between a straight line passing through another end point and perpendicular to the second straight line and a straight line passing through the peak point and perpendicular to the second straight line.

According to an exemplary embodiment of the present disclosure, the processor may identify that the distribution shape condition is satisfied based on an area where the peak point is located among a left area and a right area separated by a straight line connecting the two end points is the left area when the contour points at the predetermined time are located on a left side of a host vehicle, identify that the distribution shape condition is satisfied based on an area where the peak point is located among the left area and the right area is the right area when the contour points at the predetermined time are located on the right side of the host vehicle, and identify that the distribution shape condition is satisfied based on the area where the peak point is located among the two areas separated by the straight line connecting the two end points is different from an area where the host vehicle is located when the contour points at the predetermined time are located in front or behind the host vehicle.

According to an exemplary embodiment of the present disclosure, the processor may identify a first break point and a second break point that are assumed to represent different objects based on a length between contour points located between one of the two end points included in the reference straight line and the peak point is greater than a reference length, and a distribution density of the contour points is less than or equal to a reference distribution density, identify a first group of contour points at the predetermined time including the first break point, and a second group of contour points at the predetermined time including the second break point, store the contour points included in the first group as one of the first object or the second object, and store the contour points included in the second group as an object different from the one of the first object or the second object. At least one contour point located between one of the two end points included in the reference straight line and the peak point may be located in an area between a straight line that passes through one of the two end points included in the reference line and is perpendicular to the reference line and a straight line that passes through the peak point and is perpendicular to the reference line.

According to an exemplary embodiment of the present disclosure, the processor may identify two areas separated by a straight line that pass through a midpoint of a line segment connecting the first break point and the second break point and are identified for separation, identify contour points included in one area including the first break point among the two areas as the first group, and identify contour points included in another area different from the one including the second break point as the second group and the two areas.

According to an exemplary embodiment of the present disclosure, the point corresponding to the first previous object box may represent a center point of the first previous object box. The point corresponding to the second previous object box may represent a center point of the second previous object box.

According to an exemplary embodiment of the present disclosure, the processor may store the separated contour points representing the first object in association with the first object, store the separated contour points representing the second object in association with the second object when validity of separation is identified as being greater than a reference value based on a number of separated contour points representing the first object and a number of separated contour points representing the second object, and store the contour points at the predetermined time in association with the integrated object, rather than separating and clustering the contour points when the validity of separation is identified as being less than or equal to the reference value based on the number of separated contour points representing the first object and the number of separated contour points representing the second object.

According to an aspect of the present disclosure, an object classification method includes identifying that a point corresponding to a first previous object box included in an object box representing a plurality of external objects at a previous time before a predetermined time and a point corresponding to a second previous object box included in the object box representing the plurality of external objects at the previous time are included in an integrated object box including contour points at the predetermined time and included in an object box representing an integrated object when part or all of contour points at a predetermined time, at which the plurality of external objects are identified as the integrated object which is one object, through a LiDAR, satisfy a distribution condition, a dispersion condition, or a distribution shape condition, separating and clustering the contour points at the predetermined time into contour points representing a first object corresponding to the first previous object box and contour points representing a second object corresponding to the second previous object box, storing the separated contour points representing the first object in association with the first object based on a number of separated contour points representing the first object and a number of separated contour points representing the second object, and storing the separated contour points representing the second object in association with the second object.

According to an exemplary embodiment of the present disclosure, the object classification method may further include swapping information related to the integrated object with information related to one of the first object and the second object and storing the information related to one of the first object and the second object in a memory space where the information related to the integrated object is stored when a number of objects stored in a memory space is greater than a predetermined number, swapping information related to an object with a lowest priority according to predetermined criteria among objects stored in the memory space with the information related to one of the first object and the second object and storing the information related to one of the first object and the second object in a memory space where the information related to an object with the lowest priority is stored when the number of objects stored in the memory space is greater than the predetermined number, swapping the information related to the integrated object with information related to the one object and storing the information related to the one object in the memory space where the information related to the integrated object is stored when the number of objects stored in the memory space is less than or equal to the predetermined number, and allocating a memory space in which information related to an object is not stored among memory spaces to information related to the different object, and then storing the information related to the different object in the allocated memory space when the number of objects stored in the memory space is less than or equal to the predetermined number.

According to an exemplary embodiment of the present disclosure, the identifying of that the point corresponding to the first previous object box included in the object box representing the plurality of external objects at the previous time before the predetermined time and the point corresponding to the second previous object box included in the object box representing the plurality of external objects at the previous time are included in the integrated object box including the contour points at the predetermined time and included in the object box representing the integrated object, when part or all of the contour points at the predetermined time, at which the plurality of external objects are identified as the integrated object which is one object, through the LiDAR, satisfy the distribution condition, the dispersion condition, or the distribution shape condition may include identifying that the dispersion condition is satisfied based on part or all of the contour points at the predetermined time being identified in both two areas separated by a straight line connecting both end points of the contour points at the predetermined time.

According to an exemplary embodiment of the present disclosure, the identifying of that the point corresponding to the first previous object box included in the object box representing the plurality of external objects at the previous time before the predetermined time and the point corresponding to the second previous object box included in the object box representing the plurality of external objects at the previous time are included in the integrated object box including the contour points at the predetermined time and included in the object box representing the integrated object, when part or all of the contour points at the predetermined time, at which the plurality of external objects are identified as the integrated object which is one object, through the LiDAR, satisfy the distribution condition, the dispersion condition, or the distribution shape condition may include identifying whether part or all of the contour points at the predetermined time satisfy the dispersion condition or satisfy the distribution shape condition based on a peak point which is a contour point furthest from a straight line connecting both end points of the contour points at the predetermined time, which are identified as representing the integrated object.

According to an exemplary embodiment of the present disclosure, the identifying of that the point corresponding to the first previous object box included in the object box representing the plurality of external objects at the previous time before the predetermined time and the point corresponding to the second previous object box included in the object box representing the plurality of external objects at the previous time are included in the integrated object box including the contour points at the predetermined time and included in the object box representing the integrated object, when part or all of the contour points at the predetermined time, at which the plurality of external objects are identified as the integrated object which is one object, through the LiDAR, satisfy the distribution condition, the dispersion condition, or the distribution shape condition may include identifying a first dispersion for a distance between a first straight line connecting one of the two end points and the peak point, and at least one contour point located between the one end point and the peak point, identifying a second dispersion for a distance between a second straight line connecting another of the two end points and the peak point, and at least one contour point located between another end point and the peak point, and identifying that the dispersion condition is satisfied based on identifying that a dispersion value of a reference straight line having a smaller dispersion value among the first dispersion and the second dispersion is included in a reference dispersion threshold range and that a dispersion value of a non-reference straight line having a larger dispersion value among the first dispersion and the second dispersion is included in a non-reference dispersion threshold range which is different from the reference dispersion threshold range. At least one contour point located between the one end point and the peak point may be located in an area between a straight line passing through the one end point and perpendicular to the first straight line and a straight line passing through the peak point and perpendicular to the first straight line. At least one contour point located between another end point and the peak point may be located in an area between a straight line passing through another end point and perpendicular to the second straight line and a straight line passing through the peak point and perpendicular to the second straight line.

According to an exemplary embodiment of the present disclosure, the identifying of that the point corresponding to the first previous object box included in the object box representing the plurality of external objects at the previous time before the predetermined time and the point corresponding to the second previous object box included in the object box representing the plurality of external objects at the previous time are included in the integrated object box including the contour points at the predetermined time and included in the object box representing the integrated object, when part or all of the contour points at the predetermined time, at which the plurality of external objects are identified as the integrated object which is one object, through the LiDAR, satisfy the distribution condition, the dispersion condition, or the distribution shape condition may include identifying that the distribution shape condition is satisfied based on an area where the peak point is located among a left area and a right area separated by a straight line connecting the two end points is the left area when the contour points at the predetermined time are located on a left side of a host vehicle, identifying that the distribution shape condition is satisfied based on an area where the peak point is located among the left area and the right area is the right area when the contour points at the predetermined time are located on the right side of the host vehicle, and identifying that the distribution shape condition is satisfied based on the area where the peak point is located among the two areas separated by the straight line connecting the two end points is different from an area where the host vehicle is located when the contour points at the predetermined time are located in front or behind the host vehicle.

According to an exemplary embodiment of the present disclosure, the separating and clustering of the contour points at the predetermined time into the contour points representing the first object corresponding to the first previous object box and the contour points representing the second object corresponding to the second previous object box may include identifying a first break point and a second break point that are assumed to represent different objects based on a length between contour points located between one of the two end points included in the reference straight line and the peak point is greater than a reference length, and a distribution density of the contour points is less than or equal to a reference distribution density, identifying a first group of contour points at the predetermined time including the first break point, and a second group of contour points at the predetermined time including the second break point, storing the contour points included in the first group as one of the first object or the second object, and storing the contour points included in the second group as an object different from the one of the first object or the second object. At least one contour point located between one of the two end points included in the reference straight line and the peak point may be located in an area between a straight line that passes through one of the two end points included in the reference line and is perpendicular to the reference line and a straight line that passes through the peak point and is perpendicular to the reference line.

According to an exemplary embodiment of the present disclosure, the separating and clustering of the contour points at the predetermined time into the contour points representing the first object corresponding to the first previous object box and the contour points representing the second object corresponding to the second previous object box may include identifying two areas separated by a straight line that pass through a midpoint of a line segment connecting the first break point and the second break point and are identified for separation, identifying contour points included in one area including the first break point among the two areas as the first group, and identifying contour points included in another area including the second break point as the second group and different from the one area among the two areas.

According to an exemplary embodiment of the present disclosure, the point corresponding to the point corresponding to the first previous object box may represent a center point of the first previous object box. The point corresponding to the second previous object box may represent a center point of the second previous object box. According to an exemplary embodiment of the present disclosure, the storing of the separated contour points representing the first object based on the number of separated contour points representing the first object and the number of separated contour points representing the second object in association with the first object and the storing of the separated contour points representing the second object in association with the second object may include storing the separated contour points representing the first object in association with the first object when validity of separation is identified as being greater than a reference value based on a number of separated contour points representing the first object and a number of separated contour points representing the second object, storing the separated contour points representing the second object in association with the second object when validity of separation is identified as being greater than a reference value based on a number of separated contour points representing the first object and a number of separated contour points representing the second object, and storing the contour points at the predetermined time in association with the integrated object, rather than separating and clustering the contour points when the validity of separation is identified as being less than or equal to the reference based on a number of separated contour points representing the first object and a number of separated contour points representing the second object.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram showing the configuration of an object classification device according to an exemplary embodiment of the present disclosure;

FIG. 2 shows an example of object tracking by an existing object classification apparatus;

FIG. 3 shows a flowchart of operation of an object classification apparatus for differentiating and storing objects in the object classification apparatus or an object classification method according to an exemplary embodiment of the present disclosure;

FIG. 4 shows an example of contour points that satisfy a distribution condition or a dispersion condition in an object classification apparatus or an object classification method according to an exemplary embodiment of the present disclosure;

FIG. 5 shows an example of the distribution shape of contour points that satisfy a distribution shape condition in an object classification apparatus or an object classification method according to an exemplary embodiment of the present disclosure;

FIG. 6 shows an example of resource allocation for storing information related to an object in an object classification apparatus or an object classification method according to an exemplary embodiment of the present disclosure;

FIG. 7 shows a flowchart of operation of an object recognition apparatus for separating and storing contour points representing a first object or a second object in the object classification apparatus or an object classification method according to an exemplary embodiment of the present disclosure;

FIG. 8 shows an example of object classification according to an existing object classification apparatus, and an example of object classification according to an object classification apparatus according to an exemplary embodiment of the present disclosure, in an object classification apparatus or an object classification method according to an exemplary embodiment of the present disclosure;

FIG. 9 shows another example of object classification according to an existing object classification apparatus, and another example of object classification according to an object classification apparatus according to an exemplary embodiment of the present disclosure in an object classification apparatus or method according to an exemplary embodiment of the present disclosure; and

FIG. 10 illustrates a computing system related to an object classification apparatus and an object classification method according to an exemplary embodiment of the present disclosure.

It may be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On another hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present disclosure, a detailed description of well-known features or functions will be ruled out in order not to unnecessarily obscure the gist of the present disclosure.

In describing the components of the exemplary embodiment of the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, include the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

Furthermore, in an exemplary embodiment of the present disclosure, the expressions “greater than” or “less than” may be used to indicate whether a specific condition is satisfied or fulfilled, but are used only to indicate examples, and do not exclude “greater than or equal to” or “less than or equal to”. A condition indicating “greater than or equal to” may be replaced with “greater than”, a condition indicating “less than or equal to” may be replaced with “less than”, a condition indicating “greater than or equal to and less than” may be replaced with “greater than and less than or equal to”. Furthermore, ‘A’ to ‘B’ means at least one of elements from A (including A) to B (including B).

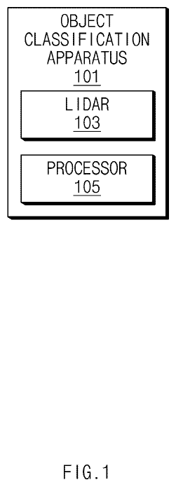

Hereinafter, various exemplary embodiments of the present disclosure will be described in detail with reference to FIGS. 1 to 10.

FIG. 1 is a block diagram showing the configuration of an object classification apparatus according to an exemplary embodiment of the present disclosure.

Referring to FIG. 1, an object classification apparatus 101 may include a LiDAR 103 and a processor 105.

At least one of the LiDAR 103 or the processor 105, or any combination thereof may be electronically and/or operably coupled with each other by an electronic component as a communication bus.

According to an exemplary embodiment of the present disclosure, hereinafter, combining pieces of hardware operatively may mean a direct connection or an indirect connection between the pieces of hardware being established in a wired or wireless manner so that the first hardware of the pieces of hardware is controlled by the second hardware of the pieces of hardware. The type and/or number of hardware included in the object classification apparatus 101 is not limited to that shown in FIG. 1. For example, the object classification apparatus 101 may include only some of hardware components shown in FIG. 1.

According to an exemplary embodiment of the present disclosure, the processor 105 of the object classification apparatus 101 may obtain location information of points of an object around a vehicle including the object classification apparatus 101 through the LiDAR 103. The processor 105 of the object classification apparatus 101 may obtain points representing the object through the LiDAR 103. The points obtained through LiDAR and representing the object may be referred to as a point cloud, but embodiments of the present disclosure may not be limited thereto.

According to an exemplary embodiment of the present disclosure, the processor 105 of the object classification apparatus 101 may extract contour points including part or all of external points among points representing an object and capable of representing the external shape of the object.

According to an exemplary embodiment of the present disclosure, the contour points may be identified in each of layers formed based on the z-axis, among the x-axis, y-axis, and z-axis. For example, the contour points may be obtained based on representative points included in a point cloud in each of the layers formed on the z-axis among the x-axis, y-axis, and z-axis. For example, the representative points may include all or part of points located outside among a plurality of points included in the point cloud. For example, a point cloud may be obtained by performing clustering based on each of points obtained by a LiDAR being identified within a predetermined distance.

According to an exemplary embodiment of the present disclosure, the processor 105 of the object classification apparatus 101 may classify an object based on contour points.

According to an exemplary embodiment of the present disclosure, the processor 105 of the object classification apparatus 101 may classify contour points into a plurality of objects at a previous time before a predetermined time. For example, contour points may be classified into points representing a first object and points representing a second object at a previous time.

According to an exemplary embodiment of the present disclosure, when the first object or the second object is an object in a moving state, the first object and the second object may move to positions close to each other.

According to an exemplary embodiment of the present disclosure, when the first object and the second object are located close to each other at a predetermined time, at least one contour point representing the first object and at least one contour point representing the second object may be identified at positions close to each other.

At the predetermined time, the processor of an existing object classification apparatus may identify that at least one contour point representing the first object and at least one point representing the second object represent an integrated object which is one object.

To prevent this, when contour points representing a plurality of external objects represent an integrated object which is a single object, the processor 105 of the object classification apparatus 101 according to various exemplary embodiments of the present disclosure may classify the contour points identified as representing the integrated object into contour points representing the first object and contour points representing the second object.

According to an exemplary embodiment of the present disclosure, to identify whether contour points representing a plurality of external objects represent an integrated object which is a single object, the processor 105 of the object classification apparatus 101 may identify whether part or all of contour points at a predetermined time satisfies a distribution condition, a dispersion condition, or a distribution shape condition, and identify that a point corresponding to a first previous object box representing a first object at a previous time before the predetermined time, and a point corresponding to a second previous object box representing a second object at the previous time are included in an integrated object box included in an object box including contour points at the predetermined time and representing an integrated object. According to an exemplary embodiment of the present disclosure, an object box may include a virtual box to which information related to an external object is assigned. For example, the object box may be referred to as a contour box.

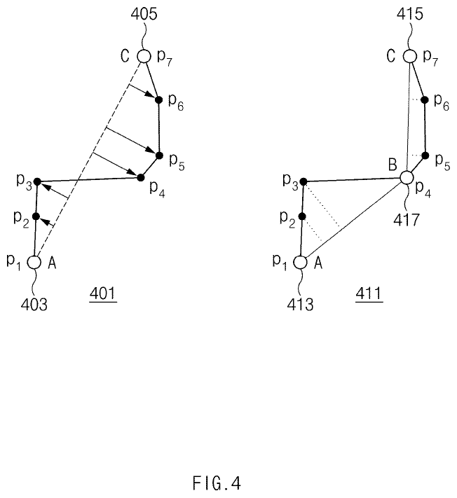

According to an exemplary embodiment of the present disclosure, the processor 105 of the object classification apparatus 101 may identify a shape of contour points at a predetermined time as a shape including two break points when part or all of the contour points at the predetermined time satisfies a distribution condition or a dispersion condition. A break point may refer to a point where a line connecting contour points in order is bent at a predetermined angle or more. The reason why the contour points are identified as representing an integrated object based on the presence of two break points is described below with reference to FIG. 4.

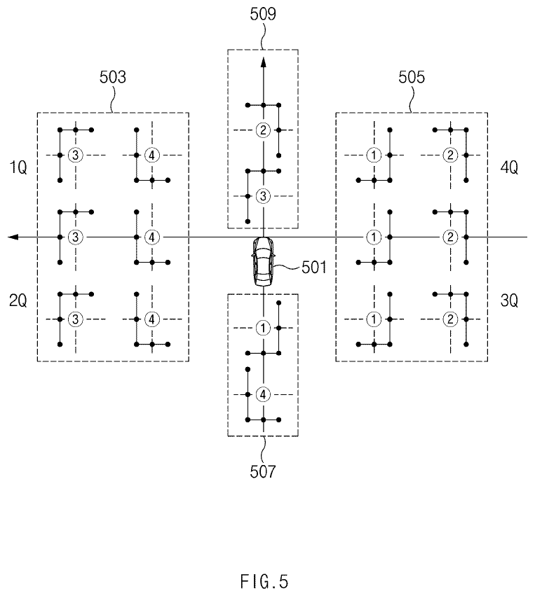

The processor 105 of the object classification apparatus 101 according to various exemplary embodiments of the present disclosure may identify a shape including one break point when part or all of contour points at a predetermined time satisfy a distribution shape condition. The reason why the contour points are identified as representing an integrated object based on the presence of one break point is described below with reference to FIG. 5.

According to an exemplary embodiment of the present disclosure, the processor 105 of the object classification apparatus 101 may separate and cluster contour points representing an integrated object into contour points representing a first object and contour points representing a second object based on a point corresponding to a first previous object box at a previous time before the predetermined time and a point corresponding to a second previous object box at the previous time being included in the integrated object box at the predetermined time. The reason for this is that, as the first object and the second object move to positions close to each other, the contour points representing the first object and the contour points representing the second object may be identified as representing the integrated object. According to an exemplary embodiment of the present disclosure, the point corresponding to the first previous object box may represent the center point of the first previous object box, and the point corresponding to the second previous object box may represent the center point of the second previous object box.

According to an exemplary embodiment of the present disclosure, the processor 105 of the object classification apparatus 101 may identify the validity of differentiation of contour points based on the number of separated contour points representing the first object and the number of separated contour points representing the second object.

When the contour points are not differentiated based on an appropriate differentiation point, the number of contour points representing one of the first object and the second object may be identified as being biased compared to the number of contour points representing another object which is different from one of the first object and the second object.

According to an exemplary embodiment of the present disclosure, the processor 105 of the object classification apparatus 101 may store separated contour points representing the first object in association with the first object and store separated contour points representing the second object in association with the second object when it is identified that the validity of differentiation is greater than a reference value based on the number of separated contour points representing the first object and the number of separated contour points representing the second object.

The processor 105 of the object classification apparatus 101 may store contour points at a predetermined time in association with an integrated object without differentiating and clustering when it is identified that the validity of differentiation is less than or equal to a reference value based on the number of separated contour points representing the first object and the number of separated contour points representing the second object.

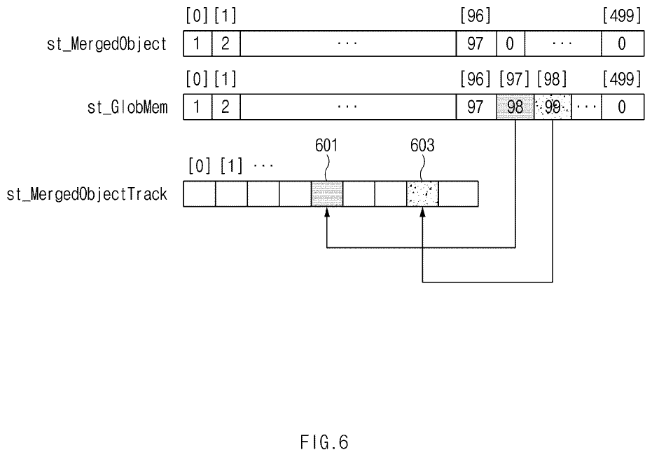

Additionally, the processor 105 of the object classification apparatus 101 may manage a memory space for storing information related to objects. Management of memory spaces is described below with reference to FIG. 6.

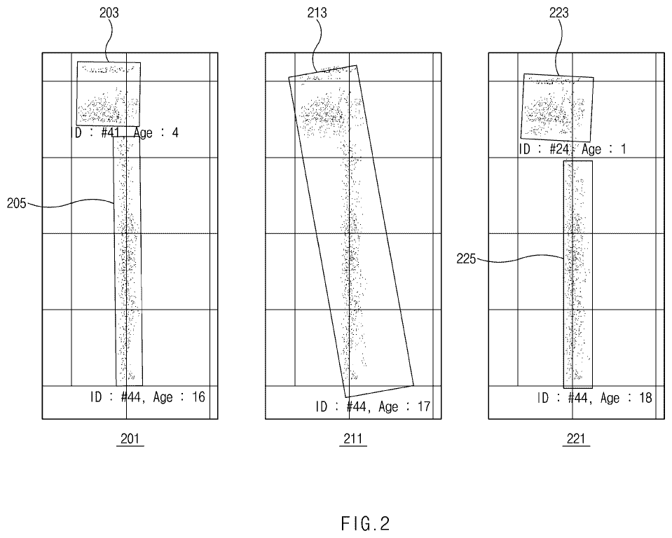

FIG. 2 shows an example of object tracking by an existing object classification apparatus.

Referring to FIG. 2, in a first frame 201, the processor of an existing object classification apparatus may identify contour points as a first object 203 and a second object 205. In a second frame 211 after the first frame 201, the processor of the existing object classification apparatus may identify contour points as a third object 213. In a third frame 221 after the second frame 211, the processor of the existing object classification apparatus may identify contour points as a fourth object 223 and a fifth object 225.

The processor of the existing object classification apparatus may identify the third object 213 of the second frame 211 as the same object as the second object 205 of the first frame 201. In other words, the processor of the existing object classification apparatus may assign the third object 213 of the second frame 211 the same identifier as the second object 205 of the first frame 201. Accordingly, the age (e.g., 17) of the third object 213 of the second frame 211 may be greater than or equal to the age (e.g., 16) of the second object 205 of the first frame 201. The age of an object may indicate the number of times the object was identified in at least one previous frame.

The processor of the existing object classification apparatus may not be able to identify contour points corresponding to the first object 203 in the second frame 211. Accordingly, tracking for the first object 203 may be ended. When the contour points representing the first object 203 are identified again at a time after the second frame 211 after tracking for the first object 203 is ended, calculation may be required again to determine the characteristics of the first object 203. Additionally, the heading direction of the object box for the third object 213 of the second frame 211 may be identified as different from the heading direction of an actual object. Due to the incorrectly recognized heading direction of the object box for the third object 213 in the second frame 211, the processor of the existing object classification apparatus may mis-recognize the third object 213 as entering a lane where the host vehicle is located. Accordingly, the performance of the system that is configured to control the host vehicle (e.g., autonomous driving system or driver assistance system) may deteriorate.

The processor of the existing object classification apparatus may identify the fifth object 225 of the third frame 221 as the same object as the second object 205 of the first frame 201 and the third object 213 of the second frame 211. In other words, the processor of the existing object classification apparatus may assign the fifth object 225 of the third frame 221 the same identifier as the identifier of the second object 205 of the first frame 201 and the identifier of the third object 213 of the second frame 211. Accordingly, the age (e.g., 18) of the fifth object 225 of the third frame 221 may be greater than or equal to the age (e.g., 17) of the third object 213 of the second frame 211 and the age (e.g., 16) of the second object 205 of the first frame 201.

The processor of the existing object classification apparatus may identify contour points corresponding to the fourth object 223 of the third frame 221 that is the same as the first object 203 of the first frame 201 in the third frame 221. Accordingly, tracking for the fourth object 223 of the third frame 221 may be started.

The processor of the existing object classification apparatus is unable to refer to information of the first object 203 of the first frame 201 with respect to the fourth object 223 of the third frame 221, even though the first object 203 of the first frame 201 and the fourth object 223 of the third frame 221 represent the same external object. Accordingly, additional calculations may be required to determine the speed of an object, determine whether the object is in a moving state, and determine a driving direction of the object.

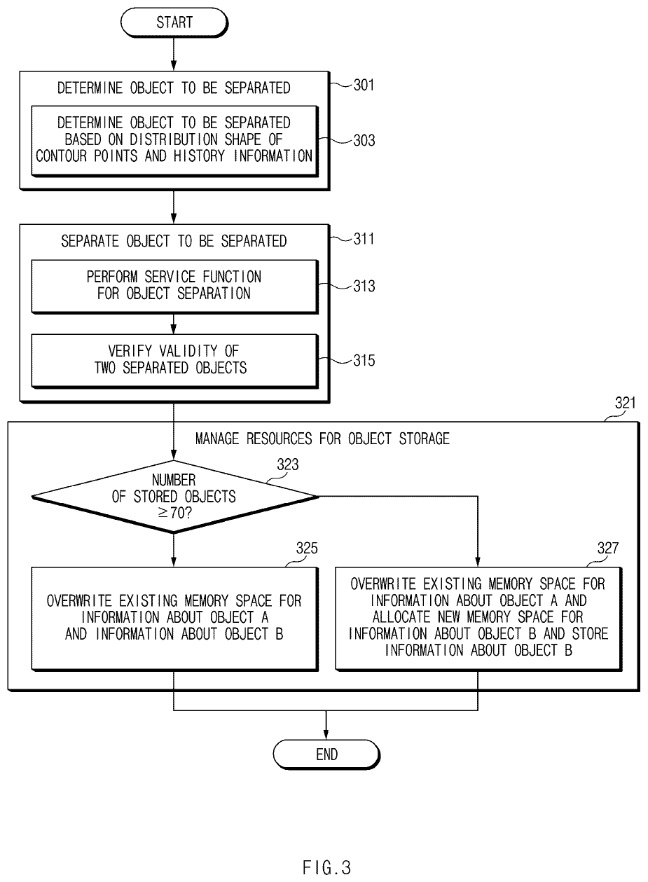

The processor of the object classification apparatus according to various exemplary embodiments of the present disclosure may classify contour points representing the third object 213 in the second frame 211 into a plurality of objects, reducing increase in calculation amount and the degree of occurrence of system performance degradation problems. Hereinafter, an object classification method of an object classification apparatus according to an exemplary embodiment will be described with reference to FIG. 3.

FIG. 3 shows a flowchart of operation of an object classification apparatus for differentiating and storing objects in the object classification apparatus or an object classification method according to an exemplary embodiment of the present disclosure.

Hereinafter, it is assumed that the object classification apparatus 101 of FIG. 1 is configured to perform the process of FIG. 3. Additionally, in the description of FIG. 3, operations described as being performed by the object classification apparatus may be understood as being controlled by the processor 105 of the object classification apparatus 101.

Referring to FIG. 3, in a first phase 301, the processor of the object classification apparatus according to various exemplary embodiments of the present disclosure may be configured to determine an object to be separated.

In a first operation 303 of the first phase 301, the processor of the object classification apparatus according to various exemplary embodiments of the present disclosure may be configured to determine an object to be separated based on the distribution type of contour points and history information.

According to an exemplary embodiment of the present disclosure, contour points to be separated may be limited to objects in a moving state (e.g., a moving vehicle) or objects capable of being in a moving state (e.g., a vehicle), but an exemplary embodiment of the present disclosure may not be limited thereto. For example, contour points may represent objects that are in a moving state (e.g., a moving vehicle) and objects incapable of being in a moving state (e.g., a road curb).

When part or all of contour points at a predetermined time satisfy a distribution condition, a dispersion condition, or a distribution shape condition, the processor of the object classification apparatus may identify whether the contour points are targets to be separated based on identifying that a point corresponding to a first previous object box at a previous time before the predetermined time, and a point corresponding to a second previous object box at the previous time are included in an integrated object box including the contour points at the predetermined time and included in an object box representing an integrated object.

In a second phase 311, the processor of the object classification apparatus according to various exemplary embodiments of the present disclosure may separate an object to be separated.

In a second operation 313 of the second phase 311, the processor of the object classification apparatus according to various exemplary embodiments of the present disclosure may perform a service function for object differentiation.

The processor of the object classification apparatus according to various exemplary embodiments of the present disclosure may find a break point based on the fact that the distribution of contour points is lower than a reference value at a point where two different objects are attached to each other.

The processor of the object classification apparatus according to another exemplary embodiment of the present disclosure may find a plurality of break points bent in the shape of a lightning bolt and separate the contour points so that the plurality of break points are included in different objects.

In a third operation 315 of the second phase 311, the processor of the object classification apparatus according to various exemplary embodiments of the present disclosure may verify the validity of the two separated objects.

According to an exemplary embodiment of the present disclosure, the processor of the object classification apparatus may identify the validity of separation for the contour points based on the number of contour points representing a separated first object and the number of contour points representing a separated second object.

In a third phase 321, the processor of the object classification apparatus according to various exemplary embodiments of the present disclosure may manage resources for object storage.

In a fourth operation 323 of the third phase 321, the processor of the object classification apparatus according to various exemplary embodiments of the present disclosure may identify whether the number of stored objects is about 70 or more. When the number of stored objects is about 70 or more, the processor of the object classification apparatus may perform a fifth operation 325 of the third phase 321. When the number of stored objects is less than about 70, the processor of the object classification apparatus may perform a sixth operation 327 of the third phase 321.

In the fifth operation 325 of the third phase 321, the processor of the object classification apparatus according to various exemplary embodiments of the present disclosure may overwrite information related to object A and information related to object B in an existing memory space.

In the sixth operation 327 of the third phase 321, the processor of the object classification apparatus according to various exemplary embodiments of the present disclosure may overwrite the information related to object an in the existing memory space, and allocate a new memory space for the information related to object B and then store the information related to object B.

FIG. 4 shows an example of contour points that satisfy a distribution condition or a dispersion condition in an object classification apparatus or an object classification method according to an exemplary embodiment of the present disclosure. The processor of the object classification apparatus according to various exemplary embodiments of the present disclosure may identify that there are two break points based on identifying that the contour points satisfy a distribution condition or a dispersion condition. A break point may refer to a contour point where a line connecting contour points in order is bent at a predetermined angle or more.

Referring to FIG. 4, a first set 401 may represent contour points at a predetermined time, which are identified as satisfying a distribution condition and representing an integrated object.

A first point 403 may represent one of both end points of the contour points at a predetermined time (e.g., point P1 and A). A second point 405 may represent the other of both the end points of the contour points at the predetermined time (e.g., point P7 and C).

A second set 411 may represent contour points at a predetermined time, which are identified as satisfying a dispersion condition and representing an integrated object. A third point 413 may represent one of both the end points of the contour points at the predetermined time (e.g., point P1 and A). A fourth point 415 may represent the other of both the end points of the contour points at the predetermined time (e.g., point P7 and C). A fifth point 417 may represent a peak point (e.g., point P4 and B), which is the furthest contour point from a straight line connecting both end points of the contour points at the predetermined time.

According to an exemplary embodiment of the present disclosure, the processor of the object classification apparatus may identify whether the distribution condition is satisfied based on identifying part or all of the contour points (e.g., P2, P3, P4, P5, and P6) at the predetermined time in both areas separated by a straight line connecting both end points of the contour points at the predetermined time (e.g., the first point 403 of the first set 401 and the second point 405 of the first set 401).

In general, when the contour points represent a single object, part or all of contour points are identified only in one area of the two areas separated by a straight line connecting both end points of the contour points (e.g., the first point 403 of the first set 401, the second point 405 of the first set 401).

According to an exemplary embodiment of the present disclosure, the processor of the object classification apparatus may identify whether part or all of contour points at the predetermined time satisfy the dispersion condition based on a peak point (e.g., the fifth point 417 of the second set 411), which is the furthest contour point from the straight line connecting both end points of the contour points at the predetermined time, which are identified as representing an integrated object.

According to an exemplary embodiment of the present disclosure, the processor of the object classification apparatus may identify a first dispersion for a distance between a first straight line connecting one of the end points (e.g., the third point 413 of the second set 411) and the peak point (e.g., the fifth point 417 of the second set 411) and at least one contour point (e.g., P2, P3) located between the one point (e.g., the third point 413 of the second set 411) and the peak point (e.g., the fifth point 417 of the second set 411).

According to an exemplary embodiment of the present disclosure, the processor of the object classification apparatus may identify a second dispersion for a distance between a second straight line connecting the other point different from the one of the end points (e.g., the fourth point 415 of the second set 411) and the peak point (e.g., the fifth point 417 of the second set 411) and at least one contour point (e.g., P5, P6) located between the other point (e.g., the fourth point 415 of the second set 411) and the peak point (e.g., the fifth point 417 of the second set 411).

According to an exemplary embodiment of the present disclosure, the processor of the object classification apparatus may identify whether the dispersion condition is satisfied based on identifying that the dispersion value of a reference line (e.g., a straight line connecting the fourth point 415 of the second set 411 and the fifth point 417 of the second set 411) including a smaller dispersion value among the first dispersion and the second dispersion falls within a reference dispersion threshold range and that the dispersion value of a non-reference line (e.g., a straight line connecting the third point 413 and the fifth point 417 of the second set 411) including a larger dispersion value among the first dispersion and the second dispersion falls within a non-reference dispersion threshold range.

According to an exemplary embodiment of the present disclosure, at least one contour point (e.g., P2 or P3) located between one point (e.g., the third point 413 of the second set 411) and a peak point (e.g., the fifth point 417 of the second set 411) may be located in an area between a straight line passing through the one point (e.g., the third point 413 of the second set 411) and perpendicular to the first straight line, and a straight line passing through the peak point (e.g., the fifth point 417 of the second set 411) and perpendicular to the first straight line.

According to an exemplary embodiment of the present disclosure, at least one contour point (e.g., P5 or P6) located between the other point (e.g., the fourth point 415 of the second set 411) and a peak point (e.g., the fifth point 417 of the second set 411) may be located in an area between a straight line passing through the other point (e.g., the fourth point 415 of the second set 411) and perpendicular to the second straight line, and a straight line passing through the peak point (e.g., the fifth point 417 of the second set 411) and perpendicular to the second straight line.

FIG. 5 shows an example of the distribution shape of contour points that satisfy a distribution shape condition in an object classification apparatus or an object classification method according to an exemplary embodiment of the present disclosure. The processor of the object classification apparatus according to various exemplary embodiments of the present disclosure may identify that there is one break point based on identifying that the contour points satisfy the distribution shape condition. A break point may refer to a point where a line connecting contour points in order is bent at a predetermined angle or more.

Referring to FIG. 5, the processor of the object classification apparatus may identify whether contour points satisfy the distribution shape condition based on identifying that contour points at a predetermined time are arranged in an included in a distribution shape included in a first group 503, a second group 505, a third group 507, or a fourth group 509.

According to an exemplary embodiment of the present disclosure, the processor of the object classification apparatus may identify global quadrants with a host vehicle 501 as an origin. According to an exemplary embodiment of the present disclosure, the processor of the object classification apparatus may identify a local quadrant in which each object represented by the contour points is the origin.

When the contour points at the predetermined time are located on the left side of the host vehicle 501, the processor of the object classification apparatus according to various exemplary embodiments of the present disclosure may identify that the distribution shape condition is satisfied based on the fact that an area where a peak point is located is the left area among the left and right areas divided by a straight line connecting both end points of the contour points, like a distribution shape included in the first group 503. The peak point may represent the contour point furthest from a straight line connecting both end points of contour points at a predetermined time, which are identified as representing an integrated object.

In other words, when the contour point belongs to the first quadrant (e.g., 1Q) or the second quadrant (e.g., 2Q) in the global quadrants, the processor of the object classification apparatus may identify that the distribution shape condition is satisfied based on the contour points belonging to the first quadrant or the second quadrant in the local quadrants.

When the contour points represent a single object located on the left side of the host vehicle 501, in general cases, it is difficult for an object located in a lane (e.g., a vehicle or a sign post) to include a concave shape to the left. Contour points including a distribution shape included in the first group 503 may be generated by an object which is relatively close to the host vehicle 501 and an object which is relatively distant from the host vehicle 501 which is located close to the close object.

When the contour points at the predetermined time are located on the right side of the host vehicle 501, the processor of the object classification apparatus according to various exemplary embodiments of the present disclosure may identify that the distribution shape condition is satisfied based on the fact that an area where a peak point is located is the right area among the left and right areas divided by a straight line connecting both end points of the contour points, like a distribution shape included in the second group 505.

In other words, when the contour point belongs to the third quadrant (e.g., 3Q) or the fourth quadrant (e.g., 4Q) in the global quadrants, the processor of the object classification apparatus may identify that the distribution shape condition is satisfied based on the contour points belonging to the third quadrant or the fourth quadrant in the local quadrants.

When the contour points represent a single object located on the right side of the host vehicle 501, in general cases, it is difficult for an object located in a lane (e.g., a vehicle, a sign post) to include a concave shape to the right. Contour points including a distribution shape included in the second group 505 may be generated by an object which is relatively close to the host vehicle 501 and an object which is relatively distant from the host vehicle 501 which is located close to the close object.

When the contour points at a predetermined time are located in front or behind the host vehicle 501, the processor of the object classification apparatus according to various exemplary embodiments of the present disclosure may identify that the distribution shape condition is satisfied based on the fact that the area where the peak point is located among the two areas separated by a straight line connecting both end points is different from the area where the host vehicle 501 is located, like a distribution shape included in the third group 507 and the fourth group 509.

In other words, when the contour point is located on an axis dividing the first quadrant (e.g., 1Q) or the fourth quadrant (e.g., 4Q) in the global quadrants, the processor of the object classification apparatus may identify that the distribution shape condition is satisfied based on the contour points belonging to the first quadrant or the fourth quadrant in the local quadrants. When the contour point is located on an axis dividing the second quadrant (e.g., 2Q) or the third quadrant (e.g., 3Q) in the global quadrants, the processor of the object classification apparatus may identify that the distribution shape condition is satisfied based on the contour points belonging to the second quadrant or the third quadrant in the local quadrants.

When the contour points represent a single object located in front or behind the host vehicle 501, in general cases, it is difficult for an object located in a lane (e.g., a vehicle or a sign post) to include a concave shape to the host vehicle. Contour points including a distribution shape included in the third group 507 or the fourth group 509 may be generated by an object which is relatively close to the host vehicle 501 and an object which is relatively distant from the host vehicle 501 which is located close to the close object.

According to an exemplary embodiment of the present disclosure, when the contour points satisfy the distribution condition or the dispersion condition as in FIG. 4 or the distribution shape condition as in FIG. 5, the processor of the object classification apparatus may separate and cluster contour points at a predetermined time into contour points representing a first object and contour points representing a second object based on a point corresponding to a first previous object box representing a first object at a previous time before the predetermined time, and a point corresponding to a second previous object box representing a second object at the previous time being included in an integrated object box representing an integrated object at the predetermined time.

According to an exemplary embodiment of the present disclosure, to separate and cluster contour points, the processor of the object classification apparatus may identify a first break point and a second break point that are estimated to represent different objects based on a length between contour points located between one of two end points included in a reference straight line and a peak point being greater than a reference length, and the distribution density of the contour points being less than or equal to a reference distribution density. This is because the contour point is not identified between two objects.

According to an exemplary embodiment of the present disclosure, the processor of the object classification apparatus may identify a first group of contour points at a predetermined time including a first break point, and a second group of contour points at the predetermined time including a second break point.

According to an exemplary embodiment of the present disclosure, the processor of the object classification apparatus may store the contour points included in the first group as one of the first object or the second object, and store the contour points included in the second group as the other of the first object or the second object, which is different from the one. At least one contour point located between one of both the end points included in the reference straight line and the peak point may be located in an area between a straight line that passes through one of the two end points included in the reference line and is perpendicular to the reference line, and a straight line that passes through the peak point and is perpendicular to the reference line.

According to another exemplary embodiment of the present disclosure, the processor of the object classification apparatus may identify two areas separated by a straight line passing the midpoint of a line segment connecting a first break point and a second break point and identified for separation, identify contour points included in one of the two areas including the first break point, as a first group, and identify contour points included in the other area which is different from the one of the two areas and includes the second break point, as the second group.

The first break point and the second break point may refer to a point where a line connecting contour points in order is bent by a predetermined angle or more. When there are two break points, the contour points may be arranged in the shape of a lightning bolt.

FIG. 6 shows an example of resource allocation for storing information related to an object in an object classification apparatus or an object classification method according to an exemplary embodiment of the present disclosure.

Referring to FIG. 6, the processor of an object classification apparatus may store information related to one of a first object and a second object in a first memory space 601. The processor of the object classification apparatus may store information related to an object different from the one of the first object and the second object in a second memory space 603.

According to an exemplary embodiment of the present disclosure, the processor of the object classification apparatus may store information related to objects into which contour points are classified in a memory space. St_Mergedobjecttrack may be a memory space for storing the state of merged objects. St_globmem may be a memory space for storing the state of a separate object. St_Manageobjecttrack may represent a memory space for storing a management state of a tracking object.

When the number of objects stored in the memory space (e.g., St_Mergedobjecttrack) is greater than a predetermined number (e.g., about 70), the processor of the object classification apparatus may swap stored information related to an integrated object with information related to one (e.g., the first object) of the first object and the second object and store the information related to the one object in the memory space (e.g., the first memory space 601), in which information related to the integrated object is stored.

When the number of objects stored in the memory space (e.g., St_Mergedobjecttrack) is greater than a predetermined number (e.g., about 70), the processor of the object classification apparatus may swap information related to an object with the lowest priority with information related to an object (e.g., the second object) different from the one object of the first object and the second object and store the information related to the object different from the one object in the memory space (e.g., the second memory space 603) in which the object with the lowest priority according to predetermined criteria is stored, among objects stored in the memory space.

When the number of objects stored in the memory space (e.g., St_Mergedobjecttrack) is less than or equal to the predetermined number (e.g., about 70), the processor of the object classification apparatus may swap information related to an integrated object with information related to one (e.g., the first object) of the first object and the second object and store the information related to the one object in the memory space (e.g., the first memory space 601), in which information related to the integrated object is stored.

When the number of objects stored in the memory space (e.g., St_Mergedobjecttrack) is less than or equal to the predetermined number (e.g., about 70), the processor of the object classification apparatus may assign a memory space in which information related to the object is not stored (e.g., the second memory space 603) among the memory spaces to information related to a different object, and then store information related to the different object in the assigned memory space.

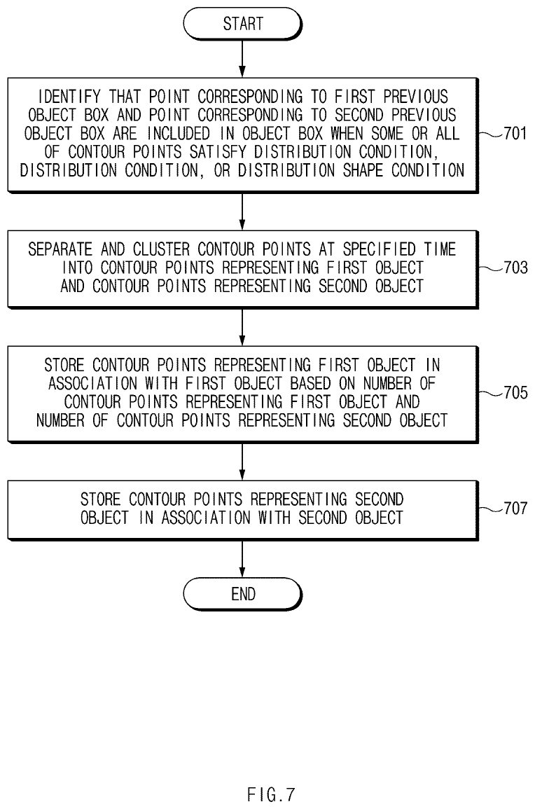

FIG. 7 shows a flowchart of operation of an object recognition apparatus for separating and storing contour points representing a first object or a second object in the object classification apparatus or an object classification method according to an exemplary embodiment of the present disclosure.

Hereinafter, it is assumed that the object classification apparatus 101 of FIG. 1 is configured to perform the process of FIG. 7. Additionally, in the description of FIG. 7, operations referred to as being performed by the object classification apparatus may be understood as being controlled by the processor 105 of the object classification apparatus 101.

Referring to FIG. 7, in a first operation 701, the processor of the object classification apparatus according to various exemplary embodiments of the present disclosure may identify that a point corresponding to a first previous object box and a point corresponding to a second previous object box are included in an object box representing an integrated object when part or all of the contour points satisfy a distribution condition, a dispersion condition, or a distribution shape condition.

According to an exemplary embodiment of the present disclosure, contour points may be obtained through a LiDAR at a predetermined time, and a plurality of external objects may be identified as an integrated object which is a single object.

In a second operation 703, the processor of the object classification apparatus according to various exemplary embodiments of the present disclosure may separate and cluster the contour points at the predetermined time into contour points representing the first object and contour points representing the second object.

According to an exemplary embodiment of the present disclosure, the first object may correspond to the first previous object box. The second object may correspond to the second previous object box.

In a third operation 705, the processor of the object classification apparatus according to various exemplary embodiments of the present disclosure may store contour points representing the first object in association with the first object based on the number of contour points representing the first object and the number of contour points representing the second object.

In a fourth operation 707, the processor of the object classification apparatus according to various exemplary embodiments of the present disclosure may store contour points representing the second object in association with the second object.

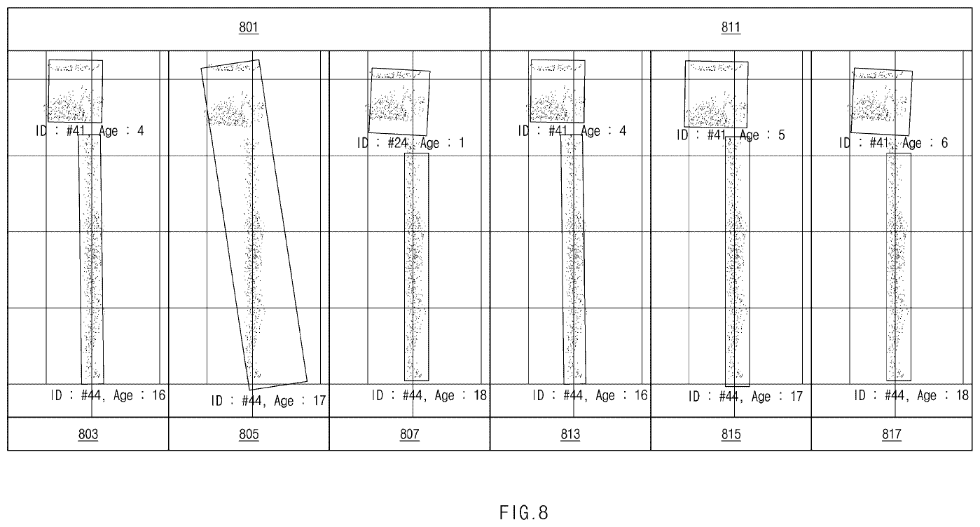

FIG. 8 shows an example of object classification according to an existing object classification apparatus, and an example of object classification according to an object classification apparatus according to an exemplary embodiment of the present disclosure, in an object classification apparatus or an object classification method according to an exemplary embodiment of the present disclosure.

Referring to FIG. 8, a first result 801 may include an example of object classification according to an existing object classification apparatus. The first result 801 may include object classification results according to contour points in a first frame 803, a second frame 805, and a third frame 807. A second result 811 may include object classification results according to contour points in a fourth frame 813, a fifth frame 815, and a sixth frame 817.

Referring to the first result 801, as in FIG. 2, the processor of the existing object classification apparatus may not identify contour points corresponding to an object located in the upper portion of the first frame 803 in the second frame 805. Accordingly, tracking of the object located in the upper portion of the first frame 803 may be ended.

In the first result 801, the upper object of the first frame 803 and the upper object of the third frame 807 may be the same external object, but may be identified as different external objects by the existing object classification apparatus.

Therefore, the identifier (e.g., 41) of the upper object of the first frame 803 and the identifier (e.g., 24) of the upper object of the third frame 807 may be different from each other. Additionally, the age of the upper object of the first frame 803 (e.g., 4) may be greater than or equal to the age of the upper object of the third frame 807 (e.g., 1).

In the first result 801, the lower object of the first frame 803 and the lower object of the third frame 807 may represent the same external object. Therefore, the lower object of the first frame 803 and the lower object of the third frame 807 may include the same identifier (e.g., 44). Additionally, the age of the lower object of the first frame 803 (e.g., 16) may be smaller than the age of the lower object of the second frame 805 (e.g., 17). The age of the lower object of the second frame 805 (e.g., 17) may be smaller than the age of the lower object of the third frame 807 (e.g., 18).

When contour points representing an object located in the upper portion of the first frame 803 are identified again at a time after the second frame 805 after tracking for an object located in the upper portion of the first frame 803 has been ended, repetitive determinations may be required to identify characteristics of an object. Furthermore, the heading direction of an object box for an object in the second frame 805 is identified differently from the heading direction of an actual object, which may deteriorate the performance of the system that is configured to control the host vehicle (e.g., autonomous driving system or driver assistance system).

Referring to the second result 811, the processor of the object classification apparatus according to various exemplary embodiments of the present disclosure may identify a contour point corresponding to an object located in the upper portion of the fourth frame 813 in the fifth frame 815. Accordingly, tracking for the object located in the upper portion of the fourth frame 813 may be continuously performed.

In the second result 811, the upper object of the fourth frame 813, the upper object of the fifth frame 815, and the upper object of the sixth frame 817 may represent the same external object. Therefore, the upper object of the fourth frame 813, the upper object of the fifth frame 815, and the upper object of the sixth frame 817 may include the same identifier (e.g., 41). Additionally, the age of the upper object of the fourth frame 813 (e.g., 4) may be smaller than the age of the upper object of the fifth frame 815 (e.g., 5). The age of the upper object of the fifth frame 815 (e.g., 5) may be smaller than the age of the upper object of the sixth frame 817 (e.g., 6).

In the second result 811, the lower object of the fourth frame 813, the lower object of the fifth frame 815, and the lower object of the sixth frame 817 may represent the same external object. Therefore, the lower object of the fourth frame 813, the lower object of the fifth frame 815, and the lower object of the sixth frame 817 may include the same identifier (e.g., 44). Additionally, the age of the lower object of the fourth frame 813 (e.g., 16) may be smaller than the age of the lower object of the fifth frame 815 (e.g., 17). The age of the lower object of the fifth frame 815 (e.g., 17) may be smaller than the age of the lower object of the sixth frame 817 (e.g., 18).

Accordingly, the processor of the object classification apparatus according to various exemplary embodiments of the present disclosure may reduce repetitive calculations when identifying characteristics of objects and improve the performance of a system that is configured to control the host vehicle compared to the existing object classification apparatus.

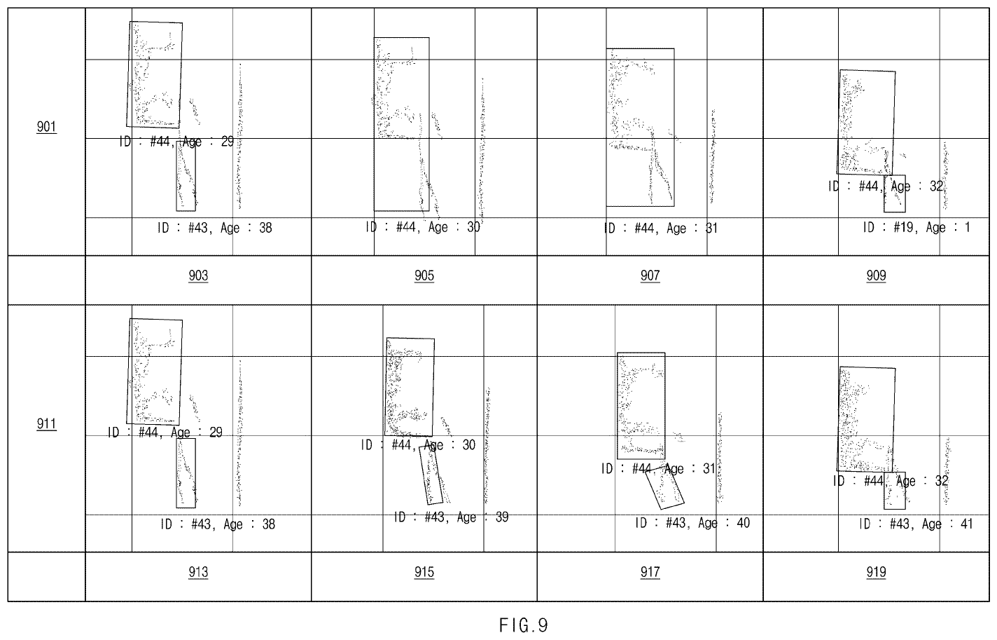

FIG. 9 shows another example of object classification according to an existing object classification apparatus, and another example of object classification according to an object classification apparatus according to an exemplary embodiment of the present disclosure in an object classification apparatus or method according to an exemplary embodiment of the present disclosure.

Referring to FIG. 9, a first result 901 may include an example of object classification according to an existing object classification apparatus. The first result 901 may include object classification results according to contour points in a first frame 903, a second frame 905, a third frame 907, and a fourth frame 909. A second result 911 may include object classification results according to contour points in a fifth frame 913, a sixth frame 915, a seventh frame 917, and an eighth frame 919.

Referring to the first result 901, the processor of the existing object classification apparatus may not identify contour points corresponding to an object located in the lower portion of the first frame 903 in the second frame 905 and the third frame 907. Accordingly, tracking of the object located in the lower portion of the first frame 903 may be ended. Additionally, the object located in the lower portion of the first frame 903 may be identified again in the fourth frame 909. However, the processor of the existing object classification apparatus may not identify whether an object identified in the first frame 903 and an object identified in the fourth frame 909 are the same external object. Therefore, in the first result 901, the lower object of the first frame 903 and the lower object of the fourth frame 909 may be the same external object, but may be identified as different external objects by the existing object classification apparatus.

Therefore, the identifier (e.g., 43) of the lower object of the first frame 903 and the identifier (e.g., 19) of the lower object of the fourth frame 909 may be different from each other. Additionally, the age (e.g., 38) of the lower object of the first frame 903 may be greater than or equal to the age (e.g., 1) of the lower object of the fourth frame 909.

In the first result 901, the upper object of the first frame 903 and the upper object of the fourth frame 909 may represent the same external object. Therefore, the upper object of the first frame 903 and the upper object of the fourth frame 909 may include the same identifier (e.g., 44). Additionally, the age of the upper object of the first frame 903 (e.g., 29) may be smaller than the age of the upper object of the second frame 905 (e.g., 30). The age of the object of the second frame 905 (e.g., 30) may be smaller than the age of the object of the third frame 907 (e.g., 31). The age of the object of the third frame 907 (e.g., 31) may be smaller than the age of the object of the fourth frame 909 (e.g., 32).

When contour points representing the lower object of the first frame 903 are identified again at a time after the second frame 905 after tracking for the lower object of the first frame 903 has been ended, repetitive calculations may be required to identify characteristics of an object. Furthermore, the heading direction of an object box for an object in the second frame 905 is identified differently from the heading direction of an actual object, which may deteriorate the performance of the system that is configured to control the host vehicle (e.g., autonomous driving system or driver assistance system).

Referring to the second result 911, the processor of the object classification apparatus according to various exemplary embodiments of the present disclosure may identify a contour point corresponding to an object located in the lower portion of the fifth frame 913, the sixth frame 915, and the seventh frame 917. Accordingly, tracking for an object located in the lower portion of the fifth frame 913 may be continuously performed.

In the second result 911, the lower object of the fifth frame 913, the lower object of the sixth frame 915, the lower object of the seventh frame 917, and the lower object of the eighth frame 919 may represent the same external object. Therefore, the lower object of the fifth frame 913, the lower object of the sixth frame 915, the lower object of the seventh frame 917, and the lower object of the eighth frame 919 include the same identifier (e.g., 43).

Additionally, the age of the lower object of the fifth frame 913 (e.g., 38) may be smaller than the age of the lower object of the sixth frame 915 (e.g., 39). The age of the lower object of the sixth frame 915 (e.g., 39) may be smaller than the age of the lower object of the seventh frame 917 (e.g., 40). The age of the lower object of the seventh frame 917 (e.g., 40) may be smaller than the age of the lower object of the eighth frame 919 (e.g., 41).

In the second result 911, the upper object of the fifth frame 913, the upper object of the sixth frame 915, the upper object of the seventh frame 917, and the upper object of the eighth frame 919 may represent the same external object. Therefore, the upper object of the fifth frame 913, the upper object of the sixth frame 915, the upper object of the seventh frame 917, and the upper object of the eighth frame 919 include the same identifier (e.g., 44).

Additionally, the age of the upper object of the fifth frame 913 (e.g., 29) may be smaller than the age of the upper object of the sixth frame 915 (e.g., 30). The age of the upper object of the sixth frame 915 (e.g., 30) may be smaller than the age of the upper object of the seventh frame 917 (e.g., 31). The age of the upper object of the seventh frame 917 (e.g., 31) may be smaller than the age of the upper object of the eighth frame 919 (e.g., 32).

Accordingly, the processor of the object classification apparatus according to various exemplary embodiments of the present disclosure may reduce repetitive determinations when identifying characteristics of objects and improve the performance of a system that is configured to control the host vehicle compared to the existing object classification apparatus.

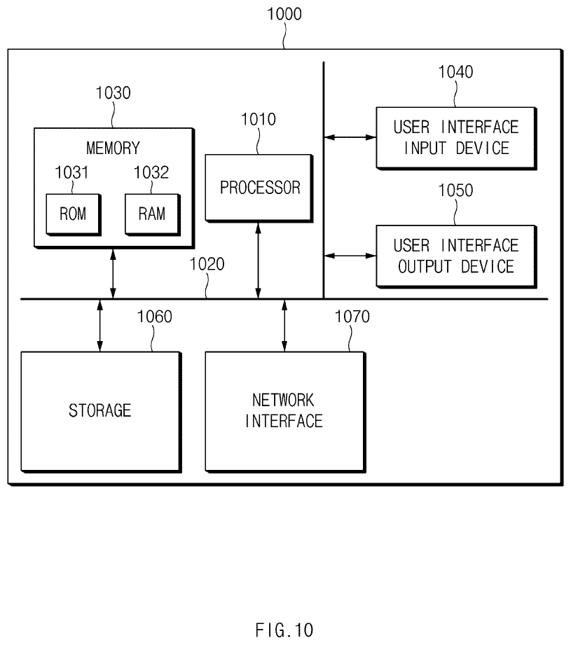

FIG. 10 illustrates a determining system related to an object classification apparatus and an object classification method according to an exemplary embodiment of the present disclosure.

Referring to FIG. 10, a computing system 1000 may include at least one processor 1010, a memory 1030, a user interface input device 1040, a user interface output device 1050, storage 1060, and a network interface 1070, which are connected to each other via a bus 1020.

The processor 1010 may be a central processing unit (CPU) or a semiconductor device that processes instructions stored in the memory 1030 and/or the storage 1060. The memory 1030 and the storage 1060 may include various types of volatile or non-volatile storage media. For example, the memory 1030 may include a Read-Only Memory (ROM) 1031 and a Random Access Memory (RAM) 1032.

Thus, the operations of the method or the algorithm described in connection with the exemplary embodiments included herein may be embodied directly in hardware or a software module executed by the processor 1010, or in a combination thereof. The software module may reside on a storage medium (that is, the memory 1030 and/or the storage 1060) such as a RAM, a flash memory, a ROM, an EPROM, an EEPROM, a register, a hard disk, a removable disk, and a CD-ROM.

The exemplary storage medium may be coupled to the processor 1010, and the processor 1010 may read information out of the storage medium and may record information in the storage medium. Alternatively, the storage medium may be integrated with the processor 1010. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Accordingly, the exemplary embodiment included in an exemplary embodiment of the present disclosure is not intended to limit the technical idea of the present disclosure but to describe the present disclosure, and the scope of the technical idea of the present disclosure is not limited by the embodiment. The scope of protection of the present disclosure should be interpreted by the following claims, and all technical ideas within the scope equivalent thereto should be construed as being included in the scope of the present disclosure.

The present technology may separate and identify a single merged object into a plurality of objects when the plurality of objects are recognized as the merged object.

The present technology may improve tracking performance for a plurality of objects.

The present technology may identify a position of an object through a LiDAR point.

The present technology may allocate a memory space for storing information related to objects.

The present technology may improve the accuracy of object separation.

Furthermore, various effects may be provided that are directly or indirectly understood through the present disclosure.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An object classification apparatus comprising:
a Light Detection and Ranging (LiDAR); and
a processor operatively connected to the LiDAR,
wherein the processor is configured to:
identify that a point corresponding to a first previous object box included in an object box representing a plurality of external objects at a previous time before a predetermined time and a point corresponding to a second previous object box included in the object box representing the plurality of external objects at the previous time are included in an integrated object box including contour points at the predetermined time and included in an object box representing an integrated object in response that part or all of the contour points at the predetermined time, at which the plurality of external objects are identified as the integrated object which is one object, through the LiDAR, satisfy a distribution condition, a dispersion condition, or a distribution shape condition;
separate and cluster the contour points at the predetermined time into contour points representing a first object corresponding to the first previous object box and contour points representing a second object corresponding to the second previous object box;
store the separated contour points representing the first object in association with the first object based on a number of separated contour points representing the first object and a number of separated contour points representing the second object; and
store the separated contour points representing the second object in association with the second object.

2. The object classification apparatus of claim 1, wherein the processor is further configured to:
swap information related to the integrated object with information related to one of the first object and the second object and store the information related to one of the first object and the second object in a memory space where the information related to the integrated object is stored in response that a number of objects stored in a memory space is greater than a predetermined number;
swap information related to an object with a lowest priority according to predetermined criteria among the objects stored in the memory space with the information related to one of the first object and the second object and store the information related to one of the first object and the second object in a memory space where the information related to an object with the lowest priority is stored in response that the number of objects stored in the memory space is greater than the predetermined number;
swap the information related to the integrated object with information related to the one object and store the information related to the one object in the memory space where the information related to the integrated object is stored in response that the number of objects stored in the memory space is less than or equal to the predetermined number; and
allocate a memory space in which information related to an object is not stored among the memory spaces to information related to a different object, and then store the information related to the different object in the allocated memory space in response that the number of objects stored in the memory space is less than or equal to the predetermined number.

3. The object classification apparatus of claim 1, wherein the processor is further configured to identify that the dispersion condition is satisfied, based on part or all of the contour points at the predetermined time being identified in both two areas separated by a straight line connecting both end points of the contour points at the predetermined time.

4. The object classification apparatus of claim 1, wherein the processor is further configured to identify whether part or all of the contour points at the predetermined time satisfy the dispersion condition or satisfy the distribution shape condition based on a peak point which is a contour point furthest from a straight line connecting both end points of the contour points at the predetermined time, which are identified as representing the integrated object.

5. The object classification apparatus of claim 4, wherein the processor is further configured to:
identify a first dispersion for a distance between a first straight line connecting one of the two end points and the peak point, and at least one contour point located between the one end point and the peak point;
identify a second dispersion for a distance between a second straight line connecting another of the two end points and the peak point, and at least one contour point located between another end point and the peak point; and
identify that the dispersion condition is satisfied based on identifying that a dispersion value of a reference straight line including a smaller dispersion value among the first dispersion and the second dispersion is included in a reference dispersion threshold range and that a dispersion value of a non-reference straight line including a larger dispersion value among the first dispersion and the second dispersion is included in a non-reference dispersion threshold range which is different from the reference dispersion threshold range,
wherein at least one contour point located between the one end point and the peak point is located in an area between a straight line passing through the one end point and perpendicular to the first straight line and a straight line passing through the peak point and perpendicular to the first straight line,
wherein at least one contour point located between another end point and the peak point is located in an area between a straight line passing through another end point and perpendicular to the second straight line, and a straight line passing through the peak point and perpendicular to the second straight line.

6. The object classification apparatus of claim 4, wherein the processor is further configured to:
identify that the distribution shape condition is satisfied based on an area where the peak point is located among a left area and a right area separated by a straight line connecting the two end points is the left area in response that the contour points at the predetermined time are located on a left side of a host vehicle;
identify that the distribution shape condition is satisfied based on an area where the peak point is located among the left area and the right area is the right area in response that the contour points at the predetermined time are located on the right side of the host vehicle; and
identify that the distribution shape condition is satisfied based on the area where the peak point is located among the two areas separated by the straight line connecting the two end points is different from an area where the host vehicle is located in response that the contour points at the predetermined time are located in front or behind the host vehicle.

7. The object classification apparatus of claim 5, wherein the processor is further configured to:
identify a first break point and a second break point that are assumed to represent different objects based on a length between contour points located between one of the two end points included in the reference straight line and the peak point is greater than a reference length, and a distribution density of the contour points is less than or equal to a reference distribution density;
identify a first group of contour points at the predetermined time including the first break point, and a second group of contour points at the predetermined time including the second break point;
store the contour points included in the first group as one of the first object or the second object; and
store the contour points included in the second group as an object different from the one of the first object or the second object,
wherein at least one contour point located between one of the two end points included in the reference straight line and the peak point is located in an area between a straight line that passes through one of the two end points included in the reference line and is perpendicular to the reference line, and a straight line that passes through the peak point and is perpendicular to the reference line.

8. The object classification apparatus of claim 7, wherein the processor is further configured to:
identify two areas separated by a straight line that pass through a midpoint of a line segment connecting the first break point and the second break point and are identified for separation;
identify contour points included in one area including the first break point among the two areas as the first group; and
identify contour points included in another area including the second break point as the second group and different from the one area among the two areas.

9. The object classification apparatus of claim 1, wherein the point corresponding to the first previous object box represents a center point of the first previous object box, and
wherein the point corresponding to the second previous object box represents a center point of the second previous object box.

10. The object classification apparatus of claim 1, wherein the processor is further configured to:
store the separated contour points representing the first object in association with the first object in response that validity of separation is identified as being greater than a reference value based on a number of separated contour points representing the first object and a number of separated contour points representing the second object;
store the separated contour points representing the second object in association with the second object in response that validity of separation is identified as being greater than a reference value based on a number of separated contour points representing the first object and a number of separated contour points representing the second object; and
store the contour points at the predetermined time in association with the integrated object, rather than separating and clustering the contour points in response that the validity of separation is identified as being less than or equal to the reference value based on the number of separated contour points representing the first object and the number of separated contour points representing the second object.

11. An object classification method comprising:
identifying that a point corresponding to a first previous object box included in an object box representing a plurality of external objects at a previous time before a predetermined time and a point corresponding to a second previous object box included in the object box representing the plurality of external objects at the previous time are included in an integrated object box including contour points at the predetermined time and included in an object box representing an integrated object in response that part or all of contour points at a predetermined time, at which the plurality of external objects are identified as the integrated object which is one object, through a Light Detection and Ranging (LiDAR), satisfy a distribution condition, a dispersion condition, or a distribution shape condition;
separating and clustering the contour points at the predetermined time into contour points representing a first object corresponding to the first previous object box and contour points representing a second object corresponding to the second previous object box;
storing the separated contour points representing the first object in association with the first object based on a number of separated contour points representing the first object and a number of separated contour points representing the second object; and
storing the separated contour points representing the second object in association with the second object.

12. The object classification method of claim 11, further including:
swapping information related to the integrated object with information related to one of the first object and the second object and storing the information related to one of the first object and the second object in a memory space where the information related to the integrated object is stored in response that a number of objects stored in a memory space is greater than a predetermined number;
swapping information related to an object with a lowest priority according to predetermined criteria among objects stored in the memory space with the information related to one of the first object and the second object and storing the information related to one of the first object and the second object in a memory space where the information related to an object with the lowest priority is stored in response that the number of objects stored in the memory space is greater than the predetermined number;
swapping the information related to the integrated object with information related to the one object and storing the information related to the one object in the memory space where the information related to the integrated object is stored in response that the number of objects stored in the memory space is less than or equal to the predetermined number; and
allocating a memory space in which information related to an object is not stored among memory spaces to information related to a different object, and then storing the information related to the different object in the allocated memory space in response that the number of objects stored in the memory space is less than or equal to the predetermined number.

13. The object classification method of claim 11, wherein the identifying of that the point corresponding to the first previous object box included in the object box representing the plurality of external objects at the previous time before the predetermined time and the point corresponding to the second previous object box included in the object box representing the plurality of external objects at the previous time are included in the integrated object box including the contour points at the predetermined time and included in the object box representing the integrated object, in response that part or all of the contour points at the predetermined time, at which the plurality of external objects are identified as the integrated object which is one object, through the LiDAR, satisfy the distribution condition, the dispersion condition, or the distribution shape condition includes identifying that the dispersion condition is satisfied based on part or all of the contour points at the predetermined time being identified in both two areas separated by a straight line connecting both end points of the contour points at the predetermined time.

14. The object classification method of claim 11, wherein the identifying of that the point corresponding to the first previous object box included in the object box representing the plurality of external objects at the previous time before the predetermined time and the point corresponding to the second previous object box included in the object box representing the plurality of external objects at the previous time are included in the integrated object box including the contour points at the predetermined time and included in the object box representing the integrated object, in response that part or all of the contour points at the predetermined time, at which the plurality of external objects are identified as the integrated object which is one object, through the LiDAR, satisfy the distribution condition, the dispersion condition, or the distribution shape condition includes identifying whether part or all of the contour points at the predetermined time satisfy the dispersion condition or satisfy the distribution shape condition based on a peak point which is a contour point furthest from a straight line connecting both end points of the contour points at the predetermined time, which are identified as representing the integrated object.

15. The object classification method of claim 14, wherein the identifying of that the point corresponding to the first previous object box included in the object box representing the plurality of external objects at the previous time before the predetermined time and the point corresponding to the second previous object box included in the object box representing the plurality of external objects at the previous time are included in the integrated object box including the contour points at the predetermined time and included in the object box representing the integrated object, in response that part or all of the contour points at the predetermined time, at which the plurality of external objects are identified as the integrated object which is one object, through the LiDAR, satisfy the distribution condition, the dispersion condition, or the distribution shape condition includes:
identifying a first dispersion for a distance between a first straight line connecting one of the two end points and the peak point, and at least one contour point located between the one end point and the peak point;
identifying a second dispersion for a distance between a second straight line connecting another of the two end points and the peak point, and at least one contour point located between another end point and the peak point; and
identifying that the dispersion condition is satisfied based on identifying that a dispersion value of a reference straight line including a smaller dispersion value among the first dispersion and the second dispersion is included in a reference dispersion threshold range and that a dispersion value of a non-reference straight line including a larger dispersion value among the first dispersion and the second dispersion is included in a non-reference dispersion threshold range which is different from the reference dispersion threshold range,
wherein at least one contour point located between the one end point and the peak point is located in an area between a straight line passing through the one end point and perpendicular to the first straight line and a straight line passing through the peak point and perpendicular to the first straight line, and
wherein at least one contour point located between another end point and the peak point is located in an area between a straight line passing through another end point and perpendicular to the second straight line, and a straight line passing through the peak point and perpendicular to the second straight line.

16. The object classification method of claim 14, wherein the identifying of that the point corresponding to the first previous object box included in the object box representing the plurality of external objects at the previous time before the predetermined time and the point corresponding to the second previous object box included in the object box representing the plurality of external objects at the previous time are included in the integrated object box including the contour points at the predetermined time and included in the object box representing the integrated object, in response that part or all of the contour points at the predetermined time, at which the plurality of external objects are identified as the integrated object which is one object, through the LiDAR, satisfy the distribution condition, the dispersion condition, or the distribution shape condition includes:
identifying that the distribution shape condition is satisfied based on an area where the peak point is located among a left area and a right area separated by a straight line connecting the two end points is the left area in response that the contour points at the predetermined time are located on a left side of a host vehicle;
identifying that the distribution shape condition is satisfied based on an area where the peak point is located among the left area and the right area is the right area in response that the contour points at the predetermined time are located on the right side of the host vehicle; and
identifying that the distribution shape condition is satisfied based on the area where the peak point is located among the two areas separated by the straight line connecting the two end points is different from an area where the host vehicle is located in response that the contour points at the predetermined time are located in front or behind the host vehicle.

17. The object classification method of claim 15, wherein the separating and clustering of the contour points at the predetermined time into the contour points representing the first object corresponding to the first previous object box and the contour points representing the second object corresponding to the second previous object box includes:
identifying a first break point and a second break point that are assumed to represent different objects based on a length between contour points located between one of the two end points included in the reference straight line and the peak point is greater than a reference length, and a distribution density of the contour points is less than or equal to a reference distribution density;
identifying a first group of contour points at the predetermined time including the first break point, and a second group of contour points at the predetermined time including the second break point;
storing the contour points included in the first group as one of the first object or the second object; and
storing the contour points included in the second group as an object different from the one of the first object or the second object,
wherein at least one contour point located between one of the two end points included in the reference straight line and the peak point is located in an area between a straight line that passes through one of the two end points included in the reference line and is perpendicular to the reference line, and a straight line that passes through the peak point and is perpendicular to the reference line.

18. The object classification method of claim 17, wherein the separating and clustering of the contour points at the predetermined time into the contour points representing the first object corresponding to the first previous object box and the contour points representing the second object corresponding to the second previous object box includes:
identifying two areas separated by a straight line that pass through a midpoint of a line segment connecting the first break point and the second break point and are identified for separation;
identifying contour points included in one area including the first break point among the two areas as the first group; and
identifying contour points included in another area including the second break point as the second group and different from the one area among the two areas.

19. The object classification method of claim 11, wherein the point corresponding to the first previous object box represents a center point of the first previous object box, and
wherein the point corresponding to the second previous object box represents a center point of the second previous object box.

20. The object classification method of claim 11, wherein the storing of the separated contour points representing the first object in association with the first object based on the number of separated contour points representing the first object and the number of separated contour points representing the second object and the storing of the separated contour points representing the second object in association with the second object includes:
storing the separated contour points representing the first object in association with the first object in response that validity of separation is identified as being greater than a reference value based on a number of separated contour points representing the first object and a number of separated contour points representing the second object;
storing the separated contour points representing the second object in association with the second object in response that validity of separation is identified as being greater than a reference value based on a number of separated contour points representing the first object and a number of separated contour points representing the second object; and
storing the contour points at the predetermined time in association with the integrated object, rather than separating and clustering the contour points in response that the validity of separation is identified as being less than or equal to the reference based on a number of separated contour points representing the first object and a number of separated contour points representing the second object.
